(19) United States
(12) Patent Application Publication
(10) Pub. No.: US 2007/0268810 A1
(43) Pub. Date: Nov. 22, 2007

(54) Optical recording medium and data storage method thereof

(75) Inventors: Ji-deog Kim, Yongin-si (KR); Jong-su Yi, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/783,634

(22) Filed: Apr. 11, 2007

(30) Foreign Application Priority Data
May 18, 2006 (KR) 10-2006-0044638

(51) Int. Cl. G11B 7/242

(52) U.S. Cl. 369/283

(57) ABSTRACT

An optical recording medium and a data storage method thereof are provided. The optical recording medium includes a base plate, a plurality of track layers, each of which stores data in a volume unit of the base plate at locations varying in a circumferential direction and a height direction of the base plate, and a storage unit in which the plurality of track layers are arranged such that the plurality of track layers, along a direction parallel to the height direction, start close to an inner circumference of the base plate, extend towards an outer circumference of the base plate and return close to the second circumference from the outer circumference in a radial direction of the base plate.

### CROSS-REFERENCE TO RELATED PATENT APPLICATIONS

This application claims priority from Korean Patent Application No. 10-2006-0044638, filed on May 18, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to an optical recording medium and a data storage method thereof and, more particularly, to an optical recording medium on which data is recorded in a volume basis and a data storage method thereof.

2. Description of the Related Art

FIG. 1 is a perspective view of a related art optical recording medium 10 for explaining a method of storing data on multiple layers separated apart from each other. Referring to FIG. 1, the related art optical recording medium 10 includes a disc-shaped base plate 20 of a light transmission material such as Polycarbonate, multiple layers 30 layered on the base plate 20 and on which data is recorded and reproduced using light scanned by an optical pickup (not shown), and a protection layer (not shown) for protecting the multiple layers 30 from external shocks or foreign substances.

For convenience of description, a virtual cylindrical coordinate system having an r axis, a θ angle, and a z axis is assumed on the center of the optical recording medium 10. Herein, the r axis is an axis of a radial direction of the optical recording medium 10, the z axis is perpendicular to the r axis and parallel to a height direction of the optical recording medium 10, and the θ angle is an angle of a circumferential direction indicating a counterclockwise rotation angle based on the r axis on a plane perpendicular to the z axis.

A track 35 having a constant track pitch in the radial direction is formed on the multiple layers 30, and data is stored on the track 35. Herein, the track pitch relates to a distance between reference numeral's 36 and 37. Although a plurality of tracks having the constant track pitch are successively formed between the inner and outer circumferences of each of the multiple layers 30, only one track 35 is illustrated for convenience of description. The track pitch has a value equal to or greater than a resolution of the radial direction. The radial direction resolution relates to the minimum distance by which each track 35 can be identified in the radial direction according to a method of recording and reproducing data.

The related art optical recording medium 10 uses a method of recording/reproducing data on a single side of a single layer. Next, a method of recording/reproducing data on double sides of a single layer has been developed, thereby recording/reproducing data on the front side and the rear side of the single layer by loading the optical recording medium 10 upside down. A method of recording/reproducing data on one side of each double layer has also been developed, thereby storing double data without loading the optical recording medium 10 upside down. According to further development of a method of recording/reproducing data on the optical recording medium 10, FIG. 1 shows the optical recording medium 10 for recording/reproducing data on the multiple layers 30.

As illustrated in FIG. 1, when the multiple layers 30 have a multi-layer structure, the multiple layers 30 are arranged not consecutively but discretely in separated locations. The multi-layer optical recording medium 10 is classified into an opposite track path (OTP) method and a parallel track path (PTP) method according to a method of formatting the multiple layers 30. Reference numeral 40 indicates a data recording/reproducing path of the PTP method, and reference numeral 50 indicates a data recording/reproducing path of the OTP method. The PTP method is a method of recording/reproducing data from the outer circumference to the inner circumference on a first layer 31 and recording/reproducing data on an adjacent second layer 32 in the same manner. The PTP method has a characteristic that each layer has the same data format, and thus, it is advantageous to use each layer as an independent data storage space. However, the PTP method has a disadvantage in that track jumping from an inner circumference to another outer circumference or from an outer circumference to another inner circumference occurs when the optical pickup moves between layers. The OTP method is a method of recording/reproducing data from the outer circumference to the inner circumference on the first layer 31 and recording/reproducing data on the adjacent second layer 32 in the opposite manner. The OTP method has a characteristic that data can be recorded/reproduced without track jumping when the optical pickup moves between layers, and thus, it is advantageous to continuously reproduce video data. However, each layer has a different data format.

As a compromise of the advantages and disadvantages of the PTP and OTP methods, a new optical recording medium 10 on which data can be continuously recorded/reproduced without track jumping and in which each of the multiple layers 30 have the same data format and a data storage method thereof are required.

In FIG. 1, each layer has a planar structure and is arranged discretely in the z axis direction of the optical recording medium 10, and data is one-dimensionally recorded/reproduced in a high/low level unit along the track 35 formed on the plane. However, many methods of three-dimensionally recording/reproducing data on the optical recording medium 10 in a volume basis have been researched, e.g., a two-photon method and a holographic method.

FIG. 2 is a plan view of an optical recording medium 10 for explaining a method of recording/reproducing data-using the holographic method. Referring to FIG. 2, the holographic method is a method of recording data on the optical recording medium 10 with a pattern of holographic data images 11 in super-high density. In the holographic method, by making a signal beam containing the holographic data images 11 interfere with a reference beam, a holographic interference pattern is generated on the optical recording medium 10. Image data can be recorded by recording the holographic interference pattern on the optical recording medium 10. To reproduce the image data from the recorded holographic interference pattern, the reference beam similar to the signal beam used to record the image data is scanned on the holographic interference pattern. The scanned reference beam causes diffraction according to the holographic interference pattern, thereby reproducing the image data.

In volumetric holography, data can be stored in high density by three-dimensionally and iteratively recording holograms in a certain volume of the optical recording medium 10 by changing a physical property of the reference beam. An image reproduced from the holographic interference pattern is composed of the holographic data image 11 of a bit or page unit and servo spots 12 added if necessary. An optical recording/reproducing apparatus (not shown) detects image capture timing by detecting locations of the servo spots 12 using a photo detector (not shown) and performs a position control for tracking and focusing.

In each servo spot 12, data for generating a reference clock, which is a reference for various kinds of operational timing, data for performing a focusing servo, data for performing a tracking servo, and an address of a data storage location are recorded.

### SUMMARY OF THE INVENTION

The present invention provides an optical recording medium for recording/reproducing data in a volume basis-thereof, significantly increasing data recording density and data recording capacity by overcoming track jumping and non-uniformity of a data format, which are disadvantages of a related art multi-layer structure, and continuously recording/reproducing the data, and a data storage method thereof.

According to an aspect of the present invention, there is provided an optical recording medium comprising: a base plate; a plurality of track layers, each of which stores data in a volume basis of the base plate at locations varying in a circumferential direction and a height direction of the base plate; and a storage unit in which the plurality of track layers are arranged such that the plurality of track layers, being continuous to each other along a direction parallel to the height direction, start close to an inner circumference of the base plate, extend towards an outer circumference of the base plate and return close to the inner circumference from the outer circumference in a radial direction of the base plate.

According to another aspect of the present invention, there is provided a data storage method of an optical recording medium comprising a base plate, a plurality of track layers for storing data, and a storage unit in which a plurality of track layers are arranged, wherein the data is stored on each of the plurality of track layers in a volume unit at locations varying in a circumferential direction and a height direction of the base plate, and the plurality of track layers are arranged in the storage unit such that the plurality of track layers, being continuous to each other along a direction parallel to the height direction, start close to an inner circumference of the base plate, extend towards an outer circumference of the base plate and return close to the inner circumference from the outer circumference in a radial direction of the base plate and continue in the height direction.

### BRIEF DESCRIPTION OF THE DRAWINGS

The above and other features and aspects of the present invention will become more apparent by describing in detail exemplary embodiments thereof with reference to the attached drawings, in which:

FIG. 1 is a perspective view of a related art optical recording medium for explaining a method of storing data on multiple layers separated apart from each other;

FIG. 2 is a plan view of a related art optical recording medium for explaining a method of recording data in a volume unit, using the holographic method;

FIGS. 3 through 8 are side cross-sectional views and perspective views of a virtual optical recording medium for comparison to an exemplary embodiment of the present invention;

FIG. 9 is a side cross-sectional view of an optical recording medium including a disc-shaped track layer according to an exemplary embodiment of the present invention;

FIG. 10 is a plan view of the optical recording medium of FIG. 9;

FIG. 11 is a side cross-sectional view of an optical recording medium including a disc-shaped track layer according to another exemplary embodiment of the present invention;

FIG. 12 is a side cross-sectional view of an optical recording medium including a spiral-shaped track layer for comparison to an exemplary embodiment of the present invention; and

FIG. 13 is a plan view of the optical recording medium of FIG. 12.

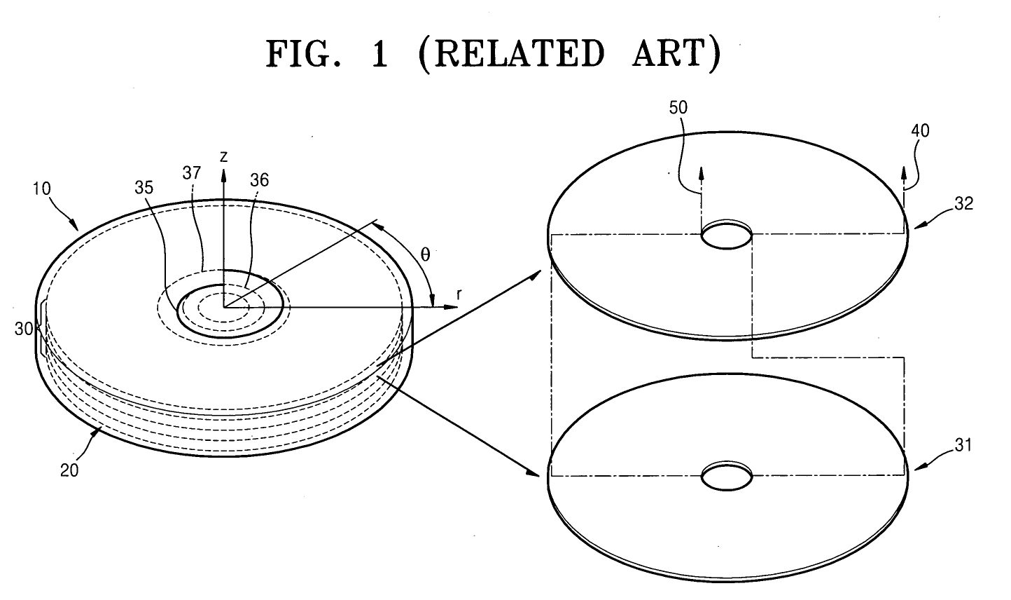

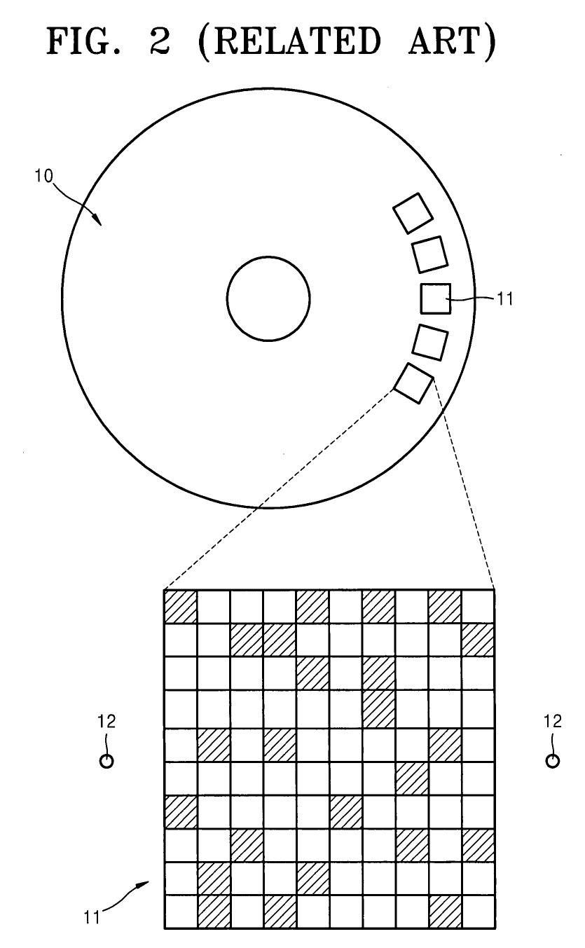

### DETAILED DESCRIPTION OF EXEMPLARY EMBODIMENTS OF THE INVENTION

The present invention will now be described more fully with reference to the accompanying drawings, in which exemplary embodiments of the invention are shown. The exemplary embodiments of the invention are not limited to the accompanying drawings, and various changes in form and details may be made therein without departing from the spirit and scope of the invention. For convenience of description, detailed dimensions or shapes may be magnified, or a ratio between the dimensions may be exaggerated. A structure of an optical recording medium and a data storage method thereof will be described together without specific distinction.

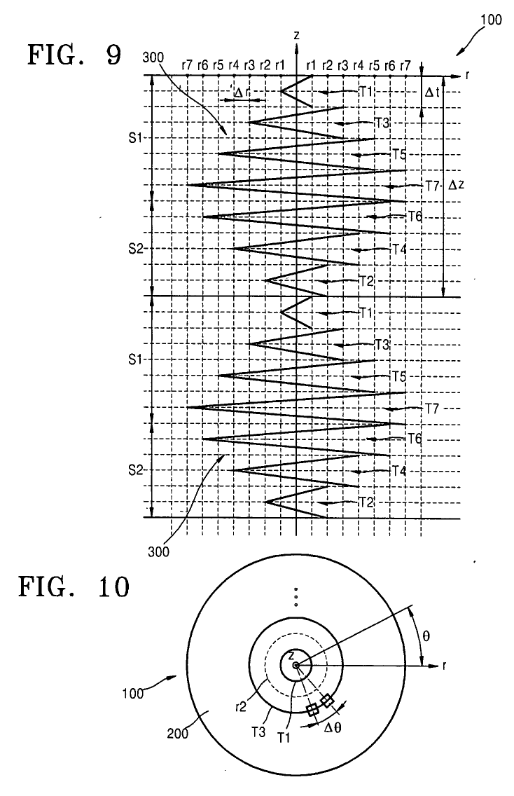

FIG. 9 is a side cross-sectional view of an optical recording medium 100 including a disc-shaped track layer T according to an exemplary embodiment of the present invention. FIG. 10 is a plan view of the optical recording medium 100 of FIG. 9. Referring to FIGS. 9 and 10, the optical recording medium 100 includes a base plate 200, the track layer T, and a plurality of storage units 300. Each of a plurality of track layers is associated with a unique order. For example, the order for a first track layer T1 is 1, and the order for a second track layer T2 is 2. A track layer can be either an odd-ordered track layer or an even-ordered track layer. For example, track layers T1, T3, T5, and T7 are odd-ordered track layers, and track layers T2, T4, and T6 are even-ordered track layers. For convenience of description, FIG. 10 shows only a first track layer T1 formed on a first circumference r1 and a third track layer T3 formed on a third circumference r3.

The base plate 200 is made of a light transmission material, such as Polycarbonate, the same as that of the related art optical recording medium. Although it is advantageous in terms of rotational vibration reduction that the base plate 200 has a disc shape, the base plate 200 can also have a polygonal shape or another shape. Data is stored on the disc-shaped track layer T having the same center as that of the base plate 200 in a volume basis, and data can be recorded/reproduced by scanning light on the track layer T. Methods of storing data in a volume basis include the two-photon method and the holographic method described above, which have been actively researched.

The holographic method will now be described in more detail. Even information that spatially overlaps can be read individually using an appropriate multiplexing scheme. That is, if recording is performed by varying an incident angle, a phase, and a wavelength of a reference beam at the same location on the optical recording medium, a plurality of holographic data can be recorded in the same volume (i.e., at the same data storage location). If a mixed-type multiplexing scheme is used, in which more than two multiplexing schemes are simultaneously used, a super-high density data storage system can be realized. To use the mixed-type multiplexing scheme, a complex optical device must be included to vary at least one of the incident angle, the phase, and the wavelength of the reference beam at the same location of the optical recording medium.

However, even though the fixed-type multiplexing scheme is not used, high density data recording/reproduction can be performed by varying a location of the optical recording medium 100 at which holographic data is stored. That is, the complex optical device can be omitted by using a holographic data recording/reproducing method whereby a data storage location is varied while scanning a reference beam having a constant physical characteristic.

It is assumed for convenience of description that there is a virtual cylindrical coordinate system in the center of the optical recording medium 100. If at least one of r axis, θ angle, and z axis coordinates of a data storage location is changed, the two data storage locations can be distinguished. For example, to distinguish two adjacent data storage locations in an r axis direction, a distance difference between the two adjacent data storage locations in the r axis direction must be equal to or greater than a resolution of the r axis direction. In addition, to distinguish two adjacent data storage locations in a θ angular direction, a separation angle Δθ between the two adjacent data storage locations must be equal to or greater than a resolution of the θ angular direction determined according to a data recording/reproducing method.

If each data storage location is distinguished with at least one of the r axis, θ angle, and z axis coordinates, data at each address can be accessed with respect to the track layer T. A coordinate difference between data storage locations must be equal to or greater than the resolution of the r axis direction, the resolution of the θ angular direction, or a resolution of the z axis direction. In a method of forming the track layer T in high density, since the track layer T is evenly distributed over the entire thickness of the z axis direction of the optical recording medium 100, data storage locations may vary continuously in the z axis direction of the base plate 200.

That is, in the current exemplary embodiment, the track layer T for storing data in a volume basis may be formed at locations continuously varying in at least one of the radial direction (r axis direction), the circumferential direction (θ angular direction) and the height direction (z axis direction) of the base plate 200.

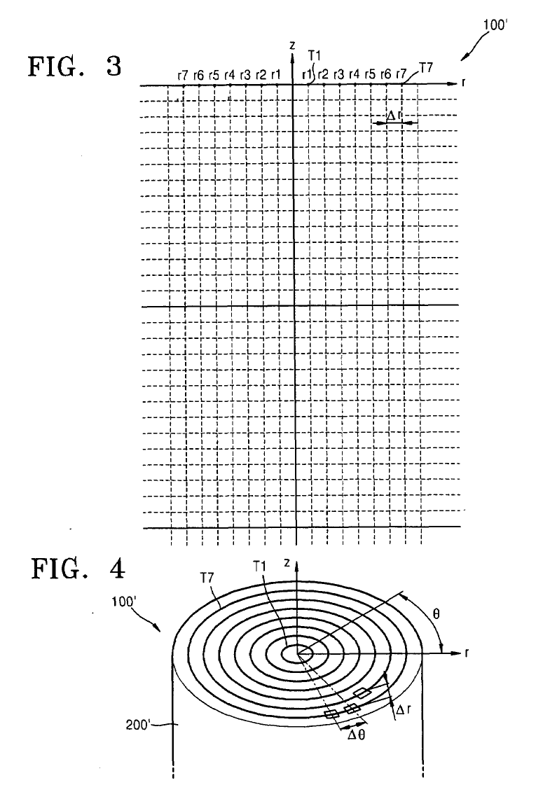

FIGS. 3 through 8 are side cross sectional views and perspective views of a virtual optical recording medium 100′ for comparison to an exemplary embodiment of the present invention. For example, a total of seven track layers T from a first track layer T1 to a seventh track layer T7 are formed between the inner circumference and the outer circumference of the optical recording medium 100′ in the radial direction, wherein a first circumference r1 to a seventh circumference r7 are virtual concentric circles separated by a constant track pitch Δr and are located in the radial direction in which each track layer T is formed.

Referring to FIG. 3, the optical recording medium 100′, having a plurality of track layers T having the same position in the z axis direction, is shown. FIG. 4 is a perspective view of the optical recording medium 100′ of FIG. 3. Track layers T shown in FIG. 4 have concentric shapes, which are separated by the constant track pitch Δr in the radial direction and have the same height in the z axis direction.

In the same track layer T, each data storage location is distinguished according to the separation angle Δθ of the θ angular direction, which has a value equal to or greater than the resolution of the θ angular direction. In different track layers T, each data storage location is distinguished by an integer multiple of the track pitch Δr in the r axis direction and by the separation angle Δθ between data storage locations in the θ angular direction. According to the data formatting method illustrated in FIGS. 3 and 4, many areas which are discarded without forming the track layers T occur, and a total length of the track layers T is short. These are definite disadvantages compared to the exemplary embodiments of the present invention illustrated in FIGS. 9 through 11.

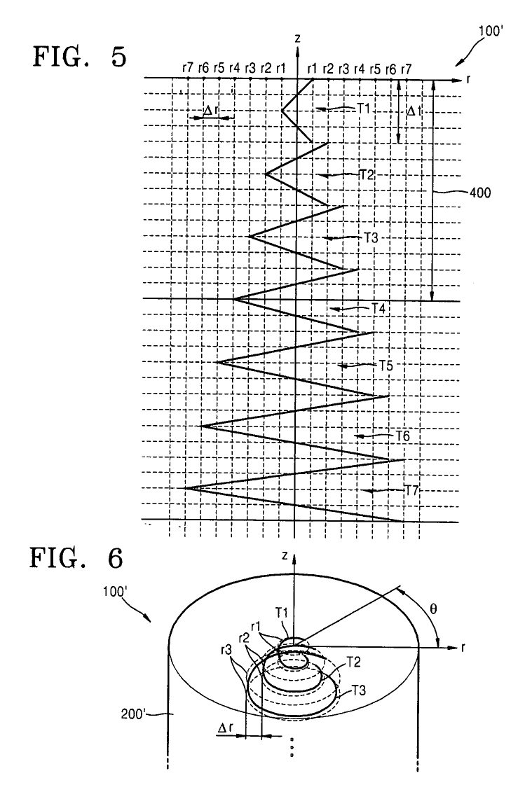

Referring to FIG. 5, an optical recording medium 100′ having track layers T, each having a large thickness Δt with data storage locations varying in the z axis direction, is shown. FIG. 6 is a perspective view of the optical recording medium 100′ of FIG. 5. The shown track layers T have a three-dimensional concentric shape, which are separated by a constant track pitch Δr in the radial direction and continue with a constant track layer thickness Δt in the z axis direction. For convenience of description, only a first track layer T1 having the same radius as that of a first circumference r1, a second track layer T2 having the same radius as that of a second circumference r2, and a third track layer T3 having the same radius as that of a third circumference r3 are shown in FIG. 6.

Although it is not shown, each data storage location in the same track layer T is distinguished according to a separation angle Δθ of the θ angular direction. In different track layers T, each data storage location is distinguished by an integer multiple of the track pitch Δr in the r axis direction and by the separation angle Δθ in the θ angular direction. According to the data formatting method illustrated in FIGS. 5 and 6, since the track layer thickness Δt is too large, the track layers T cannot be integrated in high density within a limited thickness of the optical recording medium 100′. This is a definite disadvantage compared to the exemplary embodiments of the present invention illustrated in FIGS. 9 through 11.

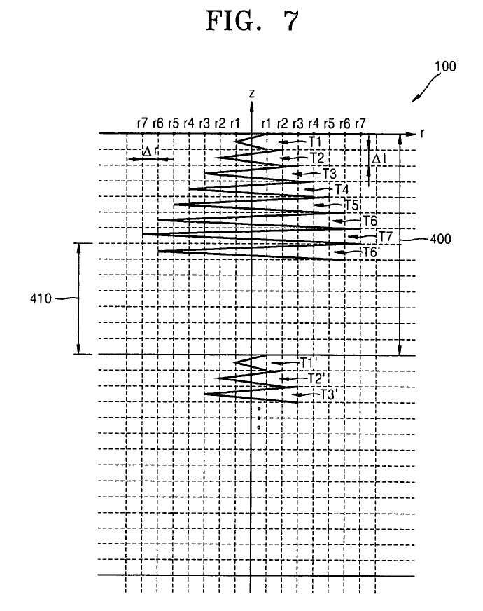

Referring to FIG. 7, an optical recording medium 100′ having track layers T, each having a small thickness Δt, is shown. The track layers T illustrated in FIG. 7 are similar to the track layers T illustrated in FIGS. 5 and 6 except that the thickness of each of the track layers T is relatively thinner. Reference numeral 400 indicates a z axis directional resolution of an optical recording/reproducing apparatus (not shown), which is determined according to an optical recording/reproducing method. In a case of two sixth track layers T6 and T6′ adjacent to a seventh track layer T7, since a separation distance in the z axis direction for data storage locations having the same r and θ angular coordinates is shorter than the z axis directional resolution 400, the data storage locations cannot be recognized as they are located in different track layers T.

In addition, in a case of two first track layers T1 and T1′ formed on opposite sides of the seventh track layer T7, data storage locations can be recognized only if data storage locations having the same r and θ angular coordinates are separated by a value equal to or greater than the z axis directional resolution 400 in the z axis direction, as they are located in different track layers T. Thus, an area 410 in which no track layer can be formed occurs, and track jumping also occurs.

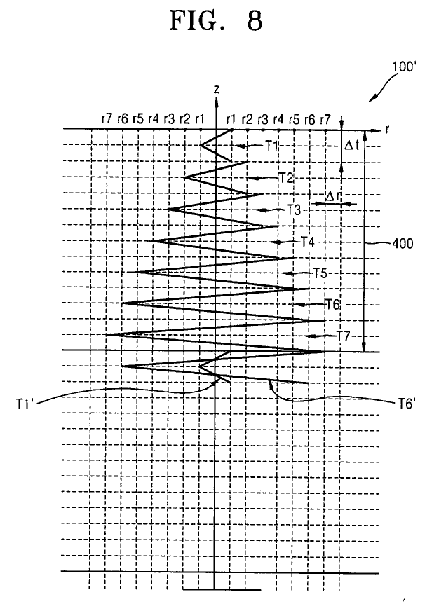

Referring to FIG. 8, an optical recording medium 100′, having an optimized track layer thickness Δt but having a great chance of track jumping occurring, is shown. Seven track layers T1 through T7 are arranged sequentially from a first circumference r1 to a seventh circumference r7 to a thickness corresponding to a z axis directional resolution in a case of two sixth track layers T6 and T6′ adjacent to the seventh track layer T7, since a separation distance in the z axis direction for data storage locations having the same r and θ angular coordinates is shorter than a z axis directional resolution 400, the data storage locations cannot be recognized as they are located in different track layers T.

However, in a case of two first track layers T1 and T1′, since data storage locations having the same r and θ angular coordinates are separated by a value greater than the z axis directional resolution 400 in the z axis direction, the data storage locations can be recognized by the optical recording/reproducing apparatus even if they are located in different track layers T. In this case, since track jumping occurs between the seventh track layer T7 and the first track layer T1′, data access time increases.

The exemplary embodiments in which a total of seven track layers T from a first track layer T1 to a seventh track layer T7 are arranged in the r axis direction between an inner circumference and an outer circumference of an optical recording medium 100 in a single storage unit 300 are illustrated in FIGS. 9 through 11. A first circumference r1 to a seventh circumference r7 are virtual concentric circles separated by a constant track pitch Δr and are located in the radial direction in which each track layer T is formed.

Referring back to FIGS. 9 and 10, the optical recording medium 100 includes the plurality of storage units 300 continuing in the z axis direction. In each of the plurality of storage units 300, a plurality of track layers T are arranged to start from an inner circumference of the optical recording medium 100 and return to the inner circumference via an outer circumference in the radial direction and continue in the height direction.

The track pitch Δr has a value equal to or greater than an r axis directional resolution. The plurality of track layers T is separated by the constant track pitch Δr in the r axis direction. Each storage unit 300 includes a first sub-unit S1 in which odd-ordered track layers T1, T3, T5, and T7 are arranged and a second sub-unit S2 in which even-ordered track layers T2, T4, and T6 are arranged.

The second sub-unit S2 continues to the first sub-unit S1 in the z axis direction. The plurality of track layers T are arranged in the first sub-unit S1 and the second sub-unit S2 in an order of increasing radius of each track layer T in a direction from the inner circumference of the optical recording medium 100 to the outer circumference. The plurality of storage units 300 may be arranged to alternatively place the first sub-unit S1 and the second sub-unit S2. By doing this, the plurality of track layers T are arranged on the optical recording medium 100 in high density without any wasted area.

To optimize arrangement of the plurality of track layers T in the r axis direction, the number of track layers T formed in each storage unit 300 may be equal to a value obtained by dividing a difference between a radius of the inner circumference of the optical recording medium 100 and a radius of the outer circumference by the track pitch Δr.

A thickness Δz of each storage unit 300 may be constant in the z axis direction and have a value equal to or greater than a z axis directional resolution. In addition, a thickness Δt of each track layer T may be constant in the z axis direction and have a value equal to a value obtained by dividing the thickness Δz of each storage unit 300 by the number of track layers T arranged in each storage unit 300 (7 in FIG. 9). Thus, the track layers T and the storage units 300 can be optimally arranged in the z axis direction.

If a plurality of track layers T are arranged in a disc shape and separated by a constant track pitch Δr in the radial direction as illustrated in FIGS. 9 and 10, when movement between two adjacent track layers T occurs, track jumping in the circumferential direction and/or the z axis direction is prevented, and track jumping in the radial direction, which is twice the track pitch Δr, occurs.

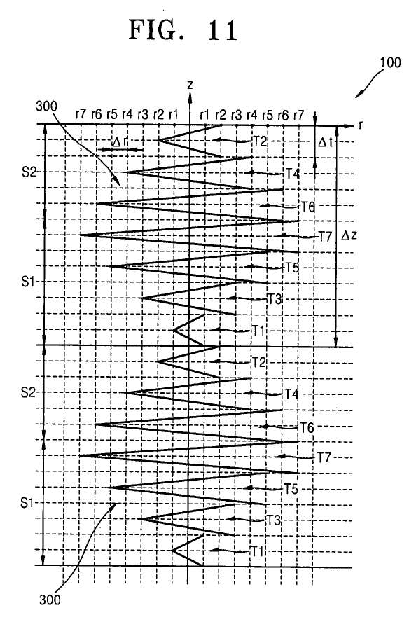

FIG. 11 is a side cross-sectional view of an optical recording medium 100 including a disc-shaped track layer T according to another exemplary embodiment of the present invention. The structure and features of the optical recording medium 100 of FIG. 11 are the same as those of FIG. 9 except that the locations of the first sub-unit S1 and the second sub-unit S2 are exchanged.

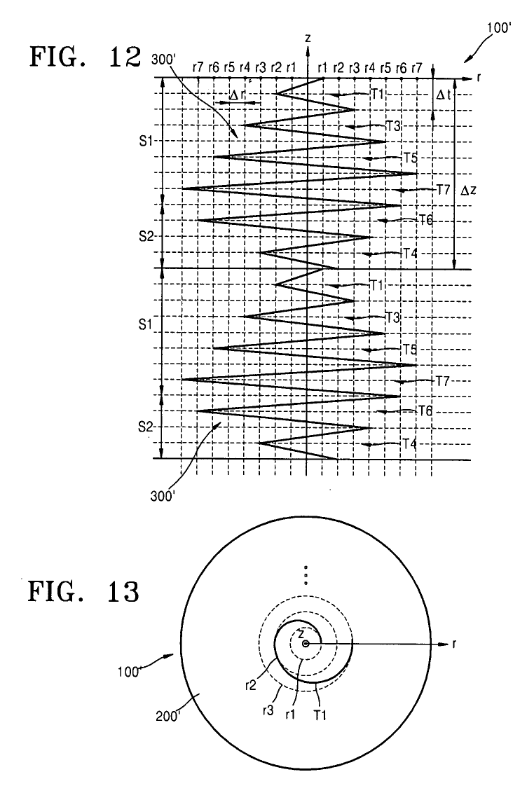

FIG. 12 is a side cross-sectional view of a virtual optical recording medium 100′ including a spiral-shaped track layer T for comparison to an exemplary embodiment of the present invention. FIG. 13 is a plan view of the optical recording medium 100′ of FIG. 12. For convenience of description, only a first track layer T1 is shown in FIG. 13. Referring to FIGS. 12 and 13, each storage unit 300′ includes a first sub-unit S1 and a second sub-unit S2, which continue in the z axis direction. Odd-ordered track layers T1, T3, T5, and T7 are continuously arranged in the first sub-unit S1, and even-ordered track layers T6 and T4 are continuously arranged in the second sub-unit S2. The first track layer T1 arranged in an inner circumference of the optical recording medium 100′ reaches a third circumference r3 by starting from a first circumference r1 in the r axis direction, rotates one turn in the θ angular direction, and has a constant track layer thickness Δt in the z axis direction. The third track layer T3 continues to the first track layer T1 and reaches a fifth circumference r5 by starting from the third circumference r3 in the r axis direction. The seventh track layer T7 is arranged between the fifth track layer T5 and the sixth track layer T6 and reaches a sixth circumference r6 by starting from a seventh circumference r7.

However, if each track layer T has a spiral shape, data storage locations vary in the spiral shape by starting from an inner circumference and returning to the inner circumference via an outer circumference along a plurality of track layers T within a single storage unit 300′. In this case, more than two data storage locations having the same radial and circumferential directional coordinates are generated, and thus the data storage locations cannot be identified because the track layers T are arranged so that a separated distance of the z axis direction between the data storage locations has a value less than a z axis directional resolution. To solve this problem, the track layer T in the exemplary embodiment of the present invention shown in FIGS. 9 through 11 has a disc shape.

Whether addresses of data storage locations are crossed in the r, θ, and z axis directions, will be described with reference to FIGS. 9 through 11. In a single storage unit 300, data storage locations in all track layers T have a coordinate difference in at least one of the r and θ angular directions (having a value greater than a resolution of each axis direction), and thus, the data storage locations are recognized as different addresses.

Since different storage units 300 have the same track layer arrangement, even though two track layers T respectively formed in two adjacent storage units 300 have the same data storage location in the r axis and θ angular directions, the data storage locations of the two track layers T are recognized as different addresses by the thickness Δz of each storage unit 300. Herein, the thickness Δz of each storage unit 300 has a value greater than the z axis directional resolution.

As described above, in an optical recording medium and a data storage method thereof, according to the present invention, confusion of addresses is prevented, data can be recorded/reproduced on a track layer, which is formed in high density, in a three-dimensional volume unit, and track jumping is reduced, thereby reducing data access time and seamlessly recording/reproducing data.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An optical recording medium comprising:
a base plate;
a plurality of track layers, each of which stores data in a volume basis of the base plate at locations varying in a circumferential direction and a height direction of the base plate; and
a storage unit in which the plurality of track layers are arranged such that the plurality of track layers, being continuous to each other along a direction parallel to the height direction, start close to an inner circumference of the base plate, extend towards an outer circumference of the base plate and return close to the inner circumference from the outer circumference in a radial direction of the base plate.

2. The optical recording medium of claim 1 further comprising additional storage units which continue in the height direction.

3. The optical recording medium of claim 2, wherein each of the locations at which the data is stored on the plurality of track layers is distinguished by at least one of a resolution of the radial direction, a resolution of the circumferential direction, and a resolution of the height direction.

4. The optical recording medium of claim 1, wherein if the plurality of track layers are separated by a constant track pitch in the radial direction, the storage unit comprises a first sub-unit in which odd-ordered track layers are arranged and a second sub-unit, which continues to the first sub-unit, in which even-ordered track layers are arranged, wherein the track pitch has a value equal to or greater than a resolution of the radial direction.

5. The optical recording medium of claim 4, wherein the plurality of track layers are arranged in the first sub-unit and the second sub-unit such that a radius of each of the track layers increases if an order of each of the plurality of track layers increases.

6. The optical recording medium of claim 5 further comprising additional storage units, wherein the first sub-unit and the second sub-unit are alternatively placed in the storage units and continue in the height direction of the base plate.

7. The optical recording medium of claim 6, wherein number of track layers arranged in each of the storage units is substantially equal to a value obtained by dividing a difference between a radius of the inner circumference of the base plate and a radius of the outer circumference of the base plate by the track pitch.

8. The optical recording medium of claim 7, wherein a thickness of each of the storage units is constant in the height direction of the base plate and has a value equal to or greater than the resolution of the height direction.

9. The optical recording medium of claim 8, wherein a thickness of each of the track layers is constant in the height direction of the base plate and is substantially equal to a value obtained by dividing the thickness of each of the storage units by the number of track layers arranged in each of the storage units.

10. The optical recording medium of claim 1, wherein if the plurality of track layers have a disc shape, which are separated by a constant track pitch in the radial direction, when movement between two adjacent track layers occurs, track jumping in the circumferential direction and/or the height direction is prevented, and track jumping occurs in the radial direction for a length of twice the track pitch.

11. A data storage method of an optical recording medium comprising a base plate, a plurality of track layers for storing data, and a storage unit in which the plurality of track layers are arranged,
wherein the data is stored on each of the plurality of track layers in a volume basis at locations varying in a circumferential direction and a height direction of the base plate, and the plurality of track layers are arranged in the storage unit such that along a direction parallel to the height direction, the plurality of track layers, being continuous to each other along a direction parallel to the height direction, start close to an inner circumference of the base plate, extend towards an outer circumference of the base plate and return to the inner circumference from the outer circumference in a radial direction of the base plate.

12. The data storage method of claim 11, wherein each of the locations at which the data is stored is distinguished by at least one of a resolution of the radial direction, a resolution of the circumferential direction, and a resolution of the height direction.

13. The data storage method of claim 11, wherein if the plurality of track layers are separated by a constant track pitch in the radial direction, the storage unit comprises a first sub-unit in which odd-ordered track layers are arranged and a second sub-unit, which continues to the first sub-unit, in which even-ordered track layers are arranged, wherein the track pitch has a value equal to or greater than the resolution of the radial direction.

14. The data storage method of claim 13, wherein the plurality of track layers are arranged in the first sub-unit and the second, sub-unit such that a radius of each of the track layers increases if an order of each of the plurality of track layers increases.

15. The data storage method of claim 14, wherein additional storage units into which the first sub-unit and the second sub-unit are alternatively placed are arranged to continue in the height direction.

16. The data storage method of claim 15, wherein number of track layers arranged in each of the storage units is substantially equal to a value obtained by dividing a difference between a radius of the inner circumference and a radius of the outer circumference by the track pitch,
a thickness of each of the storage units is constant in the height direction and has a value equal to or greater than the resolution of the height direction, and
a thickness of each of the track layers is constant in the height direction and is substantially equal to a value obtained by dividing the thickness of each of the track layers by the number of track layers arranged in each of the storage units.

17. The data storage method of claim 11, wherein if the plurality of track layers have a disc shape, which are separated by a constant track pitch in the radial direction, when movement between two adjacent track layers occurs, track jumping in the circumferential direction and/or the height direction is prevented, and track jumping occurs in the radial direction for a length of twice the track pitch.
